(19) United States
(12) Patent Application Publication
(10) Pub. No.: US 2026/0258681 A1
(43) Pub. Date: Sep. 3, 2026

(54) MOTOR VEHICLE INTERIOR DOOR HANDLE ASSEMBLIES WITH HELICAL CAM AND/OR INERTIA INTERLOCK

(71) Applicant: FORD GLOBAL TECHNOLOGIES, LLC, Dearborn, MI (US)

(72) Inventors: Daniel J. Osterhoff, Northville, MI (US); Jackson Wright, Laverton, (AU)

(21) Appl. No.: 19/068,249

(22) Filed: Mar. 3, 2025

(51) Int. Cl. E05B 85/12; E05B 77/06

(52) U.S. Cl. CPC E05B 85/12; E05B 77/06

(57) ABSTRACT

Interior door handle assemblies are provided for motor vehicles. An exemplary interior door handle assembly may include a helical cam, an inertia interlock, or both. The helical cam may be provided at an interface between a handle and a cam slider of the interior door handle assembly and may be configured for converting a user-actuated rotation of the handle to linear displacement of the cam slider. The inertia interlock may substantially prevent a non-user actuated inertial rotation of the handle that can result from acceleration forces acting on the assembly.

### TECHNICAL FIELD

This disclosure relates generally to motor vehicles, and more particularly to vehicle interior door handle assemblies that include helical cam features for providing transverse operation, inertia interlock features for preventing inertial rotation, or both.

### BACKGROUND

Motor vehicles include doors with handles. The handles are provided on both the exterior and the interior of each door and can be utilized to open or close the vehicle doors.

### SUMMARY

An interior door handle assembly for a motor vehicle, according to an exemplary aspect of the present disclosure includes, among other things, a door handle, a cam slider, and a helical cam provided at an interface between the door handle and the cam slider. The helical cam is configured to convert a rotational movement of the door handle into a linear translation of the cam slider.

In a further non-limiting embodiment of the foregoing interior door handle assembly, the door handle is a vertical paddle style door handle.

In a further non-limiting embodiment of either of the foregoing interior door handle assemblies, a chassis and a first pin pivotably connect the door handle to the chassis.

In a further non-limiting embodiment of any of the foregoing interior door handle assemblies, the first pin slidably connects the cam slider relative to the door handle and the chassis.

In a further non-limiting embodiment of any of the foregoing interior door handle assemblies, a first spring is configured to bias the cam slider towards one side of the chassis.

In a further non-limiting embodiment of any of the foregoing interior door handle assemblies, a second pin operably connects the cam slider to the chassis. The cam slider is configured to slide along the first pin and the second pin during the linear translation.

In a further non-limiting embodiment of any of the foregoing interior door handle assemblies, the helical cam is established by a lever arm of the door handle and a helical cam surface of the cam slider.

In a further non-limiting embodiment of any of the foregoing interior door handle assemblies, the helical cam surface extends along a helical path. Movement of the lever arm along the helical path provided by the helical cam surface effectuates the linear translation of the cam slider.

In a further non-limiting embodiment of any of the foregoing interior door handle assemblies, an inertia lock paddle pivotably connects to the door handle, and an inertia interlock is configured to prevent an inertial rotation of the door handle when an acceleration force acts on the interior door handle assembly.

In a further non-limiting embodiment of any of the foregoing interior door handle assemblies, the inertia lock paddle provides a first stop surface of the inertia interlock, and a chassis of the interior door handle assembly provides a second stop surface of the inertia interlock.

An interior door handle assembly for a motor vehicle, according to another exemplary aspect of the present disclosure includes, among other things, a door handle, an inertia lock paddle pivotably connected to the door handle, and an inertia interlock configured to prevent an inertial rotation of the door handle when an acceleration force acts on the interior door handle assembly.

In a further non-limiting embodiment of the foregoing interior door handle assembly, the door handle is a vertical paddle style door handle.

In a further non-limiting embodiment of either of the foregoing interior door handle assemblies, the inertia lock paddle provides a first stop surface of the inertia interlock, and a chassis of the interior door handle assembly provides a second stop surface of the inertia interlock.

In a further non-limiting embodiment of any of the foregoing interior door handle assemblies, the first stop surface is part of a leg of the inertia lock paddle, and the second stop surface is part of a mounting arm of the chassis.

In a further non-limiting embodiment of any of the foregoing interior door handle assemblies, in a first position of the inertia interlock, the first stop surface is engaged to the second stop surface to prevent the inertial rotation of the door handle, and in a second position of the inertia interlock, the first stop surface is disengaged from the second stop surface to permit a user-actuated rotation of the door handle.

In a further non-limiting embodiment of any of the foregoing interior door handle assemblies, a biasing member rotationally biases the inertia lock paddle relative to the door handle to force the first stop surface into engagement with the second stop surface.

In a further non-limiting embodiment of any of the foregoing interior door handle assemblies, a pivot prong of one of the door handle or the inertia lock paddle is engaged to a pivot housing of the other of the door handle or the inertia lock paddle to pivotably connect the inertia lock paddle to the door handle.

In a further non-limiting embodiment of any of the foregoing interior door handle assemblies, the assembly includes a cam slider, and a helical cam is provided at an interface between the door handle and the cam slider. The helical cam is configured to convert a rotational movement of the door handle into a linear translation of the cam slider.

In a further non-limiting embodiment of any of the foregoing interior door handle assemblies, the helical cam is established by a lever arm of the door handle and a helical cam surface of the cam slider. The helical cam surface extends along a helical path.

A motor vehicle according to another exemplary aspect of the present disclosure includes, among other things, a door, and an interior door handle assembly secured to the door and including a helical cam, an inertia interlock, or both.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 is a perspective view of a motor vehicle.

FIG. 2 illustrates an interior portion of a door of the vehicle of FIG. 1

FIG. 3 is a blown up view of select portions of the interior portion of the door of FIG. 2.

FIG. 4 is a front perspective view of an interior door handle assembly of the vehicle door of FIGS. 2-3.

FIG. 5 is a rear perspective view of the interior door handle assembly of FIG. 4.

FIG. 6 illustrates an actuated position of the interior door handle assembly of FIGS. 4-5.

FIGS. 7 and 8 illustrate an exemplary helical cam of a vehicle interior door handle assembly.

FIGS. 9, 10, and 11 illustrate an exemplary inertia interlock of a vehicle interior door handle assembly.

### DETAILED DESCRIPTION

This disclosure details interior door handle assemblies for motor vehicles. An exemplary interior door handle assembly may include a helical cam, an inertia interlock, or both. The helical cam may be provided at an interface between a handle and a cam slider of the interior door handle assembly and may be configured for converting a user-actuated rotation of the handle to linear displacement of the cam slider. The inertia interlock may substantially prevent a non-user actuated inertial rotation of the handle that can result from acceleration forces acting on the assembly. These and other features of this disclosure are described in greater detail in the following paragraphs of this detailed description.

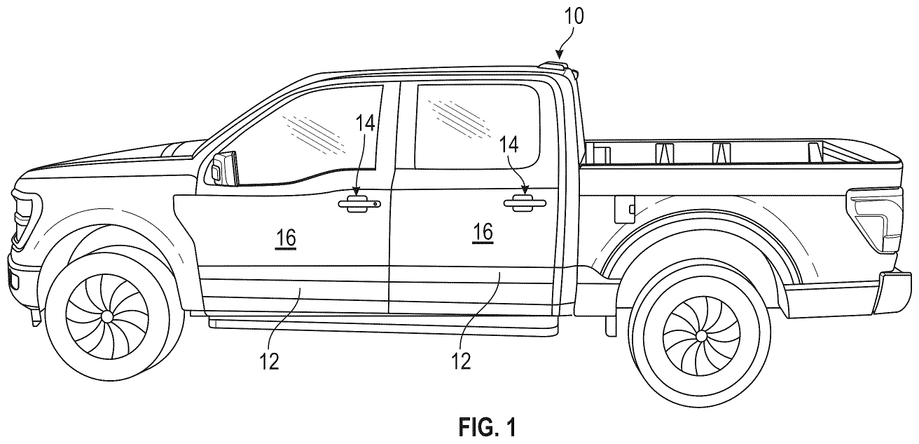

FIG. 1 schematically illustrates a motor vehicle 10 (hereinafter referred to simply as “the vehicle”). The vehicle 10 may be a pickup truck, a car, a van, a sport utility vehicle, or any other type of motor vehicle. The vehicle 10 could also be a conventional motor vehicle, a battery powered hybrid or electric vehicle, or an autonomous vehicle.

Although a specific component relationship is illustrated in the figures of this disclosure, the illustrations are not intended to limit this disclosure. The placement and orientation of the various components of the vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

The vehicle 10 may include front and rear doors, which are collectively referred to herein as the doors 12. In the illustrated embodiment, a four door vehicle is depicted. However, this disclosure extends to vehicles having one or more doors.

Each door 12 of the vehicle 10 may include an exterior door handle assembly 14. The exterior door handle assembly 14 may be secured at an exterior surface 16 of the door 12. Provided the exterior door handle assembly 14 is accessible and the door 12 is unlatched, a user can pull the exterior door handle assembly 14 to move the door 12 from the closed position shown in FIG. 1 to an open position. The user can gain ingress into the vehicle 10 when the door 12 is in the open position.

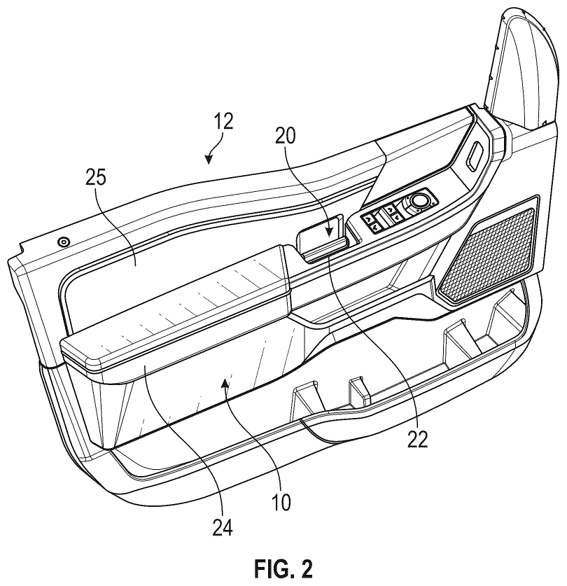

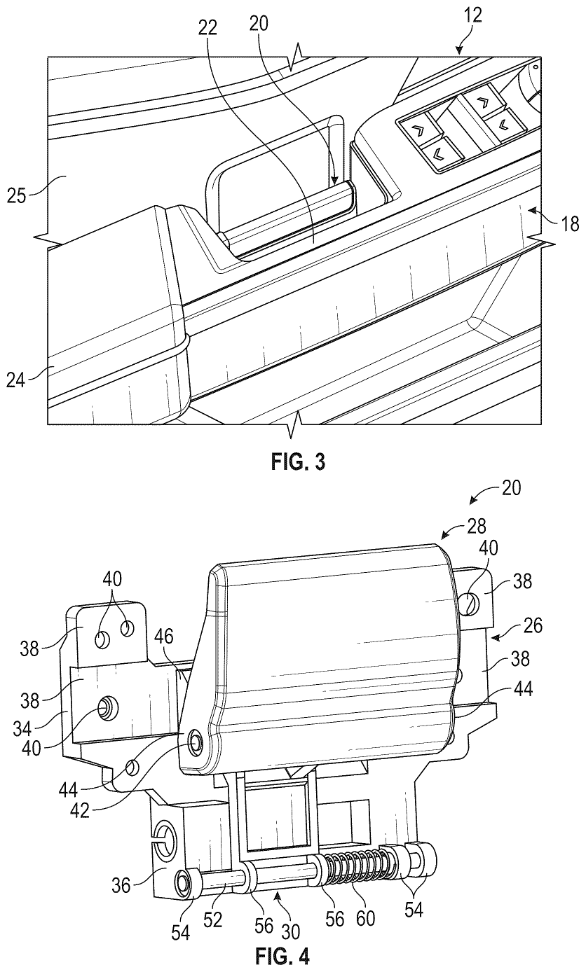

FIGS. 2 and 3 illustrate an interior surface 18 of one of the doors 12 of the vehicle 10 of FIG. 1. An interior door handle assembly 20 may be secured at the interior surface 18 of the door 12. For example, the interior door handle assembly 20 may be mounted within a pull cup 22 of an armrest 24 of the door 12, and a trim panel 25 of the door 12 may cover portions of the interior door handle assembly 20.

A user can actuate (e.g., by pulling) the interior door handle assembly 20 to unlatch the door 12. The door 12 may then be moved between open and closed positions from inside a passenger cabin of the vehicle 10.

Some existing interior door handle assemblies rely on complex mechanisms such as bell cranks that provide an inefficient transfer of force when moving the handle to unlatch the door. In addition, relatively expensive components such as counterweights are typically required to prevent inertial handle rotation when acceleration forces act upon the handle assembly. This disclosure is therefore directed to interior door handle assemblies that can provide a more efficient transfer of force with less deflection and fewer components than existing systems and/or that can prevent inertial handle rotation without using counterweights.

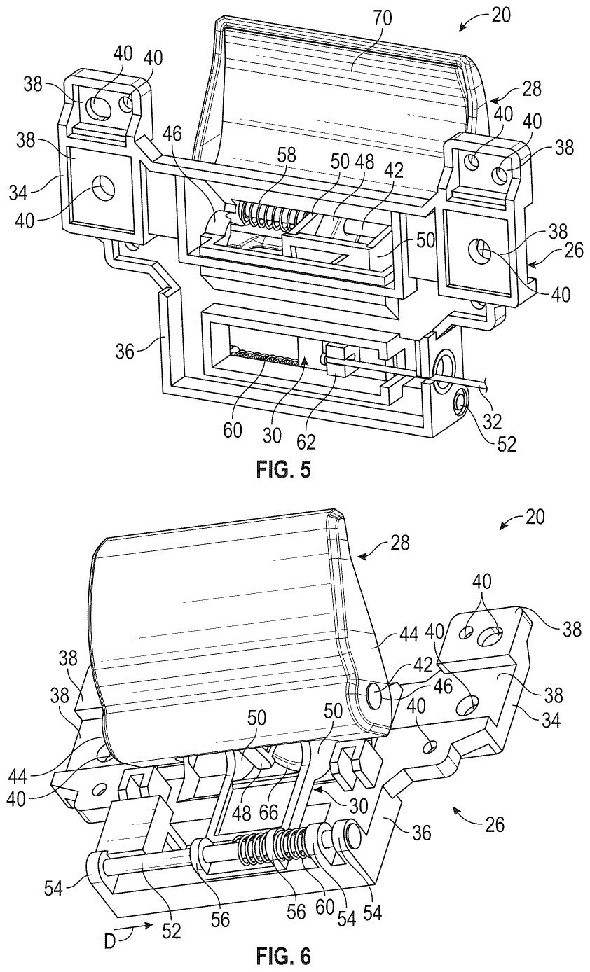

FIGS. 4-8 illustrate an exemplary interior door handle assembly 20 for a vehicle door, such as the door 12 shown in FIGS. 2-3, for example. The interior door handle assembly 20 may include a chassis 26, a handle 28, and a cam slider 30. As further discussed below, the chassis 26, the handle 28, and the cam slider 30 may be operably connected to one another for effectuating linear translation of a cable 32 (e.g., a Bowden cable, which is schematically shown in FIG. 5) of a door latching mechanism in order to unlatch the door 12.

The chassis 26 may include an upper body section 34 and a lower body section 36. The upper body section 34 and the lower body section 36 may be integrally formed to provide a unitary, single piece construction of the chassis 26. The size and shape of the chassis 26 are not intended to limit this disclosure.

The upper body section 34 may include a plurality of mounting platforms 38. Each mounting platform 38 may include one or more mounting holes 40. The mounting holes 40 may each be sized to receive a fastener (not shown) for mounting the chassis 26, and thus the interior door handle assembly 20, to an internal structure of the door 12.

In an embodiment, the handle 28 is a vertical paddle style handle that can be pulled in a direction toward the pull cup 22 to unlatch the door 12. However, other types of handles could be utilized as part of the interior door handle assembly 20 within the scope of this disclosure.

The handle 28 may be pivotably connected to the chassis 26 by a first pin 42. The first pin 42 may connect the handle 28 to the upper body section 34 of the chassis 26. The first pin 42 may be received through opening end walls 44 of the handle 28, through mounting arms 46 of the upper body section 34, and through a lever arm 48 of the handle 28 for pivotably connecting the handle 28 to the chassis 26.

The first pin 42 may additionally operably connect the handle 28 to the cam slider 30. For example, the first pin 42 may additionally be received through mounting arms 50 of the cam slider 30 for operably connecting the chassis 26, the handle 28, and the cam slider 30 together.

The cam slider 30 may be further operably connected to the chassis 26 by a second pin 52. The second pin 52 may connect the cam slider 30 to the lower body section 36 of the chassis 26. The second pin 52 may be received through mounting tabs 54 of the lower body section 36 of the chassis 26 and further through mounting tabs 56 of the cam slider 30 for further operably connecting the cam slider 30 to the chassis 26.

A first spring 58 may be received about the first pin 42, and a second spring 60 may be received about the second pin 52. The first spring 58 and the second spring 60 may cooperate to bias the cam slider 30 to a default position toward one side of the chassis 26. The default position is a non-actuated position that occurs when a rotational force is not being applied to the handle 28 by a user. The default position is shown in FIGS. 4-5.

The first spring 58 may extend between one of the mounting arms 46 of the upper body section 34 and one of the mounting arms 50 of the cam slider 30, and the second spring 60 may extend between one of the mounting tabs 54 of the lower body section 36 of the chassis 26 and one of the mounting tabs 56 of the cam slider 30.

The cam slider 30 may linearly translate or slide relative to the chassis 26 when a rotational force is applied to the handle 28. The first pin 42 and the second pin 52 may guide the translational movement of cam slider 30. The interior door handle assembly 20 moves to an actuated position (see FIG. 6) when a rotational force is being applied to the handle 28 by the user.

The cam slider 30 may include a cable attachment prong 62 (see FIGS. 5 and 8). The cable 32 may be secured to the cam slider 30 by the cable attachment prong 62 in order to operably connect the cable 32 to the interior door handle assembly 20.

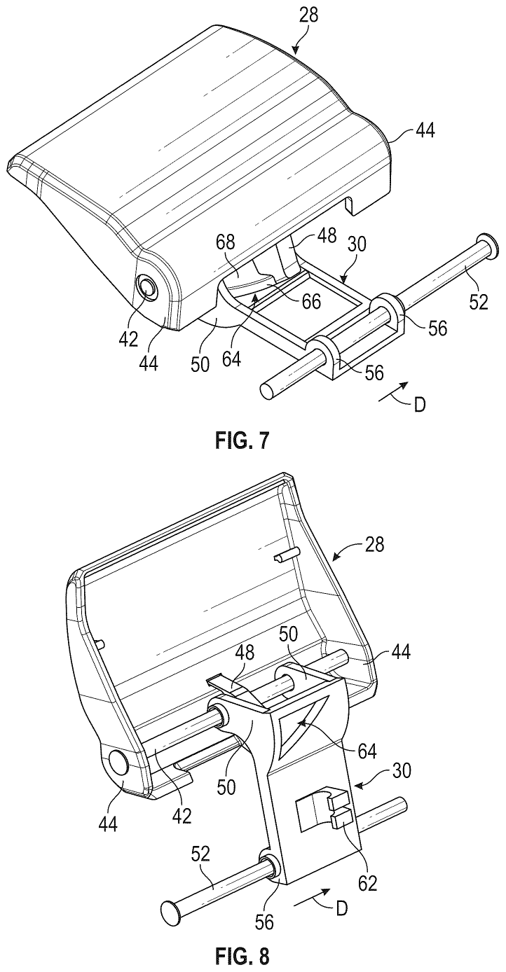

Referring now primarily to FIGS. 7-8, the interior door handle assembly 20 may include a helical cam 64 for efficiently providing the load transfer necessary to actuate the cable 32 for unlatching the door 12. As further detailed below, the helical cam 64 may function to convert a rotational force applied to the handle 28 to a linear displacement of the cam slider 30 and thus the cable 32.

The helical cam 64 may be provided at an interface between the lever arm 48 of the handle 28 and the cam slider 30. The lever arm 48 may provide a first portion of the helical cam 64, and the cam slider 30 may provide a second portion of the helical cam 64. As the handle 28 is pivoted about the first pin 42 in response to a rotational force applied by a user, the lever arm 48 may engage and travel along a helical cam surface 66 formed in an outer facing wall 68 of the cam slider 30. The helical cam surface 66 may extend along a helical path. Thus, movement of the lever arm 48 along the helical path provided by the helical cam surface 66 can effectuate movement of the cam slider 30 along a travel direction D that is opposite from the default position of the cam slider 30 shown in FIGS. 4-5. The cam slider 30 can thus slide or translate along the first pin 42 and the second pin 52 and thereby linearly translate the cable 32 a sufficient distance for unlatching the door 12. Notably, the transfer of force from the handle 28 to the cam slider 30 through the helical cam 64 can minimize slide travel losses under variable latch actuation load conditions.

Referring now to FIGS. 5 and 9-11, the interior door handle assembly 20 may include an inertia lock paddle 70 that is connectable to the handle 28. In an embodiment, the inertia lock paddle 70 is pivotably connected to the handle 28. For example, a pivot prong 74 of the handle 28 may be received within a pivot housing 76 of the inertia lock paddle 70 (or vice versa). The inertia lock paddle 70 may slightly pivot relative to the handle 28 about the pivot prong 74 when a force F is applied to the handle 28 and/or the inertia lock paddle 70 by a user. In an embodiment, the inertia lock paddle 70 is coupled to the handle 28 at about a 90 degree angle, which prevents rotation of the handle 28 until the inertia lock paddle 70 has been pivoted about its pivot connection.

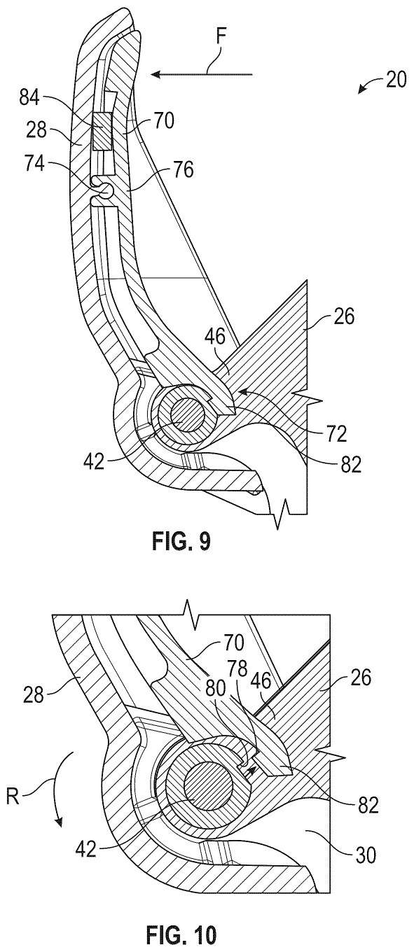

The handle 28, the chassis 26, and the inertia lock paddle 70 may cooperate to provide an inertia interlock 72 (see FIG. 9) of the interior door handle assembly 20. The inertia interlock 72 is configured to prevent unwanted, non-user actuated rotation of the handle 28 about the first pin 42, such as when acceleration forces act upon the interior door handle assembly 20, for example. The acceleration forces may act on the interior door handle assembly 20 when a side force is applied at the exterior surface 16 of the door 12.

A leg 82 of the inertia lock paddle 70 may provide a first stop surface 78 of the inertia interlock 72, and the mounting arm 46 of the chassis 26 may provide a second stop surface 80 of the inertia interlock 72. Although one pair of stop surfaces is illustrated in the exemplary embodiment of FIGS. 9-11, a person of ordinary skill in the art having the benefit of this disclosure would understand that an additional leg of the inertia lock paddle 70 and an additional mounting arm of the chassis 26 could function to provide an additional pair of stop surfaces of the inertia interlock 72.

In the default, resting, or non-rotated position of the handle 28 shown in FIG. 9, the first stop surface 78 may engage the second stop surface 80 of the inertia interlock 72 to prevent a non-user actuated inertial rotation of the handle 28. A moment of inertia of the inertia interlock 72 forces the first and second stop surfaces 78, 80 into engagement with one another and can thus prevent the handle 28 from rotating even when acceleration forces act on the exterior surface 16 of the door 12.

A biasing member 84 may be positioned between the handle 28 and the inertia lock paddle 70. The biasing member 84 may be located vertically between the pivot connection provided by the pivot prong 74 and the pivot housing 76 and respective upper edges of the handle 28 and the inertia lock paddle 70. The biasing member 84 may be configured to rotationally bias (here, in a clockwise direction) the inertia lock paddle 70 relative to the handle 28 in order to force the first and second stop surfaces 78, 80 into engagement with one another.

A center of gravity of the inertia lock paddle 70 may be located below the pivot connection provided by the pivot prong 74 and the pivot housing 76. This can help prevent actuation of the handle 28 that would otherwise be possible due to a center of gravity of the handle 28 being located above the pivot connection. The inertia interlock 72 may therefore eliminate the need for including counterweights within the design of the interior door handle assembly 20.

In an embodiment, the biasing member 84 is a foam block. However, other types of biasing members could alternatively be utilized within the scope of this disclosure.

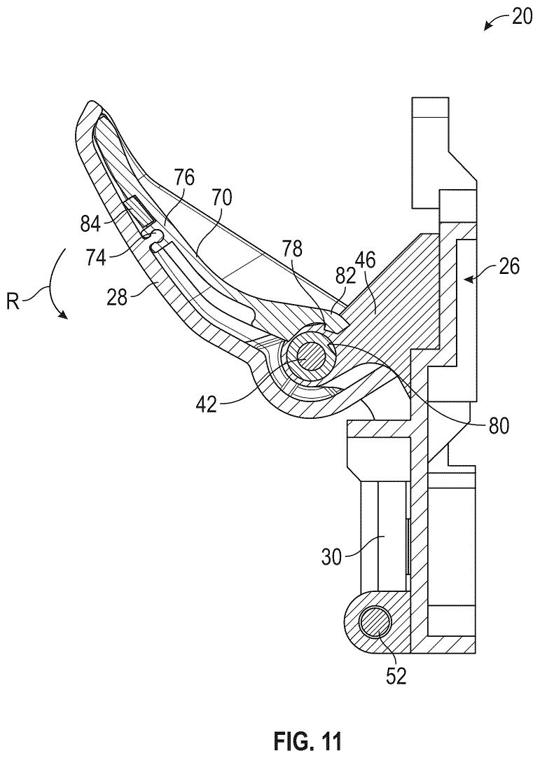

A user may selectively apply the force F to manually rotate the handle 28 about the first pin 42. The force F may further cause the inertia lock paddle 70 to pivot about the pivot prong 74 (here, in a counterclockwise direction) relative to the handle 28, thereby causing the first stop surface 78 to move to a disengaged position (see FIGS. 10 and 11) with respect to the second stop surface 80 and thus allow the handle 28 to be rotated in a rotation direction R for unlatching the door 12. The handle 28 is shown in a fully rotated position in FIG. 11.

In an embodiment, a return spring force of the biasing member 84 is lower than the force required to actuate the handle 28. The inertia lock paddle 70 will therefore pivot to unlock the handle 28 for rotation prior to loading the handle 28 at its initial rotational starting force.

When the user release the handle 28 such that the force F is no longer being applied, the handle 28 returns to the default position of FIG. 9. As a result, the cam slider 30 and the inertia interlock 82 can likewise both return to their home or default positions.

The interior door handle assemblies of this disclosure may include the helical cam, the inertia interlock, or both. The helical cam may be configured for converting handle rotation into linear displacement of the cam slider in a manner that more efficiently transfers force with less deflection and fewer component compared to existing door handle assemblies. The inertia interlock may substantially prevent inertial rotation of the handle due to acceleration forces acting on the assembly without the need for counterweights.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

1. An interior door handle assembly for a motor vehicle, the interior door handle assembly comprising:
a door handle;
a cam slider; and
a helical cam assembly provided at an interface between the door handle and the cam slider, the helical cam assembly being configured to convert a rotational movement of the door handle into a linear translation of the cam slider, wherein the helical cam assembly includes a helical cam surface that extends along a helical path.

2. The interior door handle assembly as recited in claim 1, wherein the door handle is a vertical paddle style door handle.

3. The interior door handle assembly as recited in claim 1, further comprising a chassis and a first pin that pivotably connects the door handle to the chassis.

4. The interior door handle assembly as recited in claim 3, wherein the first pin slidably connects the cam slider relative to the door handle and the chassis.

5. The interior door handle assembly as recited in claim 4, further comprising a first spring configured to bias the cam slider towards one side of the chassis.

6. The interior door handle assembly as recited in claim 3, further comprising a second pin that operably connects the cam slider to the chassis, wherein the cam slider is configured to slide along the first pin and the second pin during the linear translation.

7. The interior door handle assembly as recited in claim 1, wherein the helical cam assembly is established by a lever arm of the door handle and the helical cam surface of the cam slider.

8. The interior door handle assembly as recited in claim 7, wherein movement of the lever arm along the helical path provided by the helical cam surface effectuates the linear translation of the cam slider.

9. The interior door handle assembly as recited in claim 1, further comprising:
an inertia lock paddle pivotably connected to the door handle; and
an inertia interlock configured to prevent an inertial rotation of the door handle when an acceleration force acts on the interior door handle assembly, wherein the inertia lock paddle provides a first stop surface of the inertia interlock, and a chassis of the interior door handle assembly provides a second stop surface of the inertia interlock.

10. (canceled)

11. An interior door handle assembly for a motor vehicle, the interior door handle assembly comprising:
a chassis;
a door handle pivotably connected to the chassis;
an inertia lock paddle pivotably connected to the door handle; and
an inertia interlock configured to prevent an inertial rotation of the door handle when an acceleration force acts on the interior door handle assembly.

12. The interior door handle assembly as recited in claim 11, wherein the door handle is a vertical paddle style door handle.

13. The interior door handle assembly as recited in claim 11, wherein the inertia lock paddle provides a first stop surface of the inertia interlock, and the chassis provides a second stop surface of the inertia interlock.

14. The interior door handle assembly as recited in claim 13, wherein the first stop surface is part of a leg of the inertia lock paddle, and the second stop surface is part of a mounting arm of the chassis.

15. The interior door handle assembly as recited in claim 14, wherein, in a first position of the inertia interlock, the first stop surface is engaged to the second stop surface to prevent the inertial rotation of the door handle, and in a second position of the inertia interlock, the first stop surface is disengaged from the second stop surface to permit a user-actuated rotation of the door handle.

16. The interior door handle assembly as recited in claim 15, wherein a biasing member rotationally biases the inertia lock paddle relative to the door handle to force the first stop surface into engagement with the second stop surface.

17. The interior door handle assembly as recited in claim 11, wherein a pivot prong of one of the door handle or the inertia lock paddle is engaged to a pivot housing of the other of the door handle or the inertia lock paddle to pivotably connect the inertia lock paddle to the door handle.

18. The interior door handle assembly as recited in claim 11, further comprising:
a cam slider; and
a helical cam assembly provided at an interface between the door handle and the cam slider, the helical cam assembly being configured to convert a rotational movement of the door handle into a linear translation of the cam slider, wherein the helical cam assembly is established by a lever arm of the door handle and a helical cam surface of the cam slider, and further wherein the helical cam surface extends along a helical path.

19. (canceled)

20. A motor vehicle, comprising:
a door; and
an interior door handle assembly secured to the door and including a helical cam assembly having a helical cam surface that extends along a helical path, an inertia interlock, or both.

21. The interior door handle assembly as recited in claim 16, wherein the biasing member is a foam block positioned between the door handle and the inertia lock paddle vertically between a pivot connection and respective upper edges of the door handle and the inertia lock paddle.

22. The interior door handle assembly as recited in claim 1, wherein the cam slider includes a cable attachment prong, and a cable is secured to the cam slider by the cable attachment prong such that the linear translation of the cam slider actuates the cable to unlatch a vehicle door.
